(19) United States
(12) Patent Application Publication
(10) Pub. No.: US 2025/0021844 A1
(43) Pub. Date: Jan. 16, 2025

(54) PRIVACY-AWARE MODELING USING GENERALIZED AND PARTITIONED MODELS

(71) Applicant: Intuit, Inc., Mountain View, CA (US)

(72) Inventors: Omer ZALMANSON, Tel-Aviv (IL); Yair HORESH, Kefar-Sava (IL); Lior TABORI, Tel-Aviv (IL)

(21) Appl. No.: 18/222,353

(22) Filed: Jul. 14, 2023

(51) Int. Cl. G06N 5/046; G06N 5/022

(52) U.S. Cl. CPC G06N 5/046; G06N 5/022

(57) ABSTRACT

Certain aspects of the disclosure provide a method for training a machine learning model to predict text containing sensitive information. The method includes extracting one or more features from a historical data set. The method further includes anonymizing the historical data set, including determining, for each feature of the extracted one or more features, tokens containing personally identifiable information (sensitive information); assigning a category placeholder to each of the tokens containing sensitive information; and generating a new data set where each token containing sensitive information is replaced with the assigned category placeholder. The method further includes determining a probability associated with each token containing sensitive information; and training a generalized model to predict anonymized text given the one or more features.

### BACKGROUND

### Field

Aspects of the present disclosure relate to generating predicted text including sensitive information with using machine learning models.

### Description of Related Art

Personally identifiable information (“PII”) is generally any representation of information that permits the identity of an individual to whom the information applies to be reasonably inferred by either direct or indirect means. PII may include information that can be used to distinguish or trace an individual's identity (e.g., name, social security number, date and place of birth, biometric records, etc.), either alone or in combination with other personal or identifying information that is linked or linkable to a specific individual (e.g., medical, educational, financial, employment information, and the like).

Breach and exploitation of PII or other sensitive information may result in harm to individuals, including identity theft, forged identity documents, financial loss, reputational harm, emotional harm, and even reduced personal safety.

In various contexts, sensitive information may be found among data used by machine learning models, for example, for training and inferencing. However, using sensitive information risks breach and exploitation.

Current methods for preventing such breach and exploitation of sensitive information in machine learning models include using partitioned models or anonymized generalized models. A partitioned models method uses a separate model for each user, trained with only that user's data. Although sensitive information may be in data used by the partitioned model, the model remains partitioned from other users and sensitive information is not exposed to other users' models. However, a single user may have insufficient data to train a robust machine learning model. This may lead to reduced performance of the model, and the model may not be generalizable, limiting its application.

An anonymized generalized model method, on the other hand, uses a generalized model trained with anonymized data. User data is anonymized to remove all sensitive information before being used to train the anonymized generalized model. For example, sensitive information may be removed entirely or partially (e.g., quasi-identifiers) from the training data set. Anonymized training data sets from multiple users are then used to train the model. This allows the model to be trained with a greater amount of data, generally more than in the case of a partitioned models method. However, removing sensitive information also removes features from the data that may be beneficial for the model during learning. Further, model output will be likewise be generalized because the sensitive information features are not used in training. For example, the predicted text will not be personalized for a user because all user sensitive information features are removed before training.

Therefore, there exists a technical problem in the art in which, on the one hand, sensitive information needs to be protected, but on the other hand, model training and performance suffers without sensitive information in the training data (e.g., for the reasons described above). Accordingly, there is a need for methods of leveraging sensitive information for improving model capability and performance without exposing or otherwise putting at risk the sensitive information.

### SUMMARY

Certain aspects provide a method for training a machine learning model to predict text containing sensitive information, comprising: obtaining a historical data set; anonymizing the historical data set, comprising: determining one or more tokens containing sensitive information from the historical data set; assigning a category placeholder to each of the one or more tokens containing sensitive information; and generating a new data set where each token containing sensitive information is replaced with the assigned category placeholder; and training a generalized model to predict anonymized text with the new data set.

Certain aspects provide for predicting text comprising sensitive information, comprising: receiving, from a first user, a prompt for predicted text; generating predicted anonymized text with a generalized model based on the prompt for predictive text; and generating predicted personalized text for the first user with a probability model associated with the first user based on the predicted anonymized text.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system for using a machine learning model architecture to generate personalized predicted text containing sensitive information.

FIG. 2 depicts an example personalized predictive model architecture for generating personalized predicted text containing sensitive information.

FIG. 3 depicts an example flowchart for predicting text containing sensitive information with a prediction model.

FIG. 4 depicts various example text predictions according to the machine learning model architectures described herein.

FIG. 5 depicts an example training system for training a prediction model to predict text containing sensitive information.

FIG. 6 depicts an example data flow for generating training data for the prediction model

FIG. 7 depicts an example method for training a machine learning model architecture to predict text containing sensitive information.

FIG. 8 depicts an example method for predicting text containing sensitive information with the machine learning model architecture described herein.

FIG. 9 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure relate to systems and methods generating predicted text including sensitive information with machine learning models.

As described above, a technical problem exists in the art in which current methods for protecting sensitive information used to train machine learning models may result in poor model performance. For example, as described briefly above, a partitioned models method uses separate models trained for each user with only that user's data in order to protect any sensitive data.

However, as described, small data sets, such as data for only one user, may not be sufficient for training complex models. Further, a model trained with only one user's data may not be generalizable. Thus, technical problems exist with a partitioned models method in these partitioned models trained with only one user's data may have poor performance and limited generalization. Additionally, as a different model is generated and maintained for each user, more time and processing resources are required. Thus, another technical problem exists with a partitioned models method which it requires extensive resources, but may not provide needed performance.

In another example, an anonymized generalized models method uses a generalized model training with anonymous data from many users. These models are generalizable and have larger training data sets. Such models may be used for additional users because the output is generalized. However, anonymizing the data may remove features associated with sensitive information, reducing utility of such models because the output is generalized and not personalized for a user. For example, a generalized model trained with anonymized data would be unable to predict a particular user's name (or other sensitive information) as part of the output, because the model was never trained with such sensitive information. Thus, an anonymized generalized models method uses one model for many users, however, the model is not personalizable for each user because sensitive information is removed before training.

Aspects described herein provide a technical solution to the aforementioned technical problems by providing a machine learning (ML) model architecture that protects sensitive information (e.g., avoiding exposure between users) while leveraging the sensitive information to train a more performant and generalizable model. Beneficially, aspects described herein, allow the ML model architecture to generate personalized output (e.g., including sensitive information) for a specific user while maintaining privacy of sensitive information among users. Further, by using a the model architecture described herein, aspects may learn from a larger, multi-user data set and improve performance as compared to separate smaller, user-specific models, while aspects may learn from a smaller-single user data set to protect sensitive user data. Thus, aspects herein combine the beneficial privacy preservation of user-specific models with the increased performance of a larger generalized model.

As described further herein, the model architecture combines aspects of partitioned (or user-specific) models and aspects of a generalized model to provide the benefits described herein. In aspects, each of one or more partitioned models may be trained with user-specific data, including sensitive information and learn from the sensitive features. User-specific data may then be anonymized and used to train the generalized model. This generalized model benefits from the large training data set comprising multi-user anonymized data during training to improve inference performance. When prompted, the generalized model inferences an anonymized output (e.g., based on anonymized training) which is then used by the partitioned model to predict the sensitive information associated with the anonymized output generated by the generalized model. Thus, the final output of the model architecture is personalized for the user, and may for example, predict output including user-specific sensitive data, without exposing the user's sensitive information to any other user.

### Example System for Predicting Text

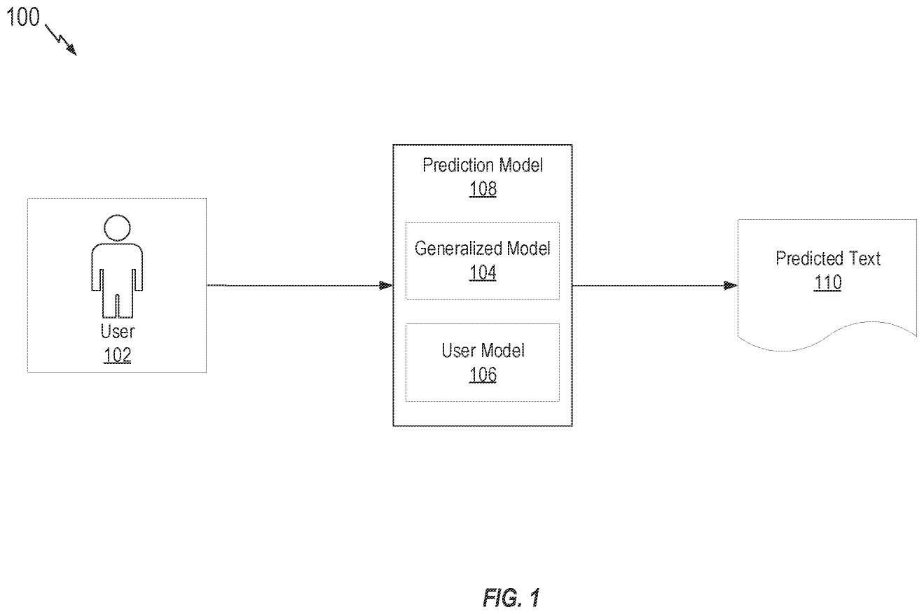

FIG. 1 depicts an example system 100 for using the model architecture described herein to generate personalized predicted text containing sensitive information.

User 102 may utilize prediction model 108 for generating predicted text 110. Predicted text 110 may be, for example, text for a document, a message, a calendar, etc. In some examples described herein, predicted text 110 includes text comprising an invoice, such as for landscaping services. Note, predictive text for an invoice is just one example use case and other example use cases are contemplated, for example, for other documents, messages, calendars, etc.

Prediction model 108 includes a generalized model 104 and a user model 106. Generalized model 104 is configured to predict anonymized text based on a prompt for predictive text. In some embodiments, generalized model 104 may be a long short-term memory (LSTM) network. A LSTM network is a recurrent neural network configured to learn long-term dependencies using feedback connections. A LSTM network predicts text based on the previous sequence of words. In some embodiments, generalized model 104 may be a transformer. A transformer is a neural network that transforms an input sequence into an output sequence, such as a text sequence.

The anonymized text output generated by generalized model 104 is provided to user model 106. User model 106 is configured to determine personalized text for user 102 based on the provided anonymized text. User model 106 may be a probabilistic model configured to determine personalized text based on the most probable sensitive information for the anonymized text. In some examples, user model 106 may be a multinomial naive Bayes classifier model. A multinomial naive Bayes classifier model may be configured to determine the most probable sensitive information for the user to replace the anonymized text, based on the anonymized text output. System 100 beneficially generates personalized text, while maintaining privacy of sensitive information but retaining the power of a generalized model.

Note, although prediction model 108 is depicted here with one user model 106, additional user models associated with additional users are contemplated.

### Example Machine Learning Model Architecture for Predicting Text

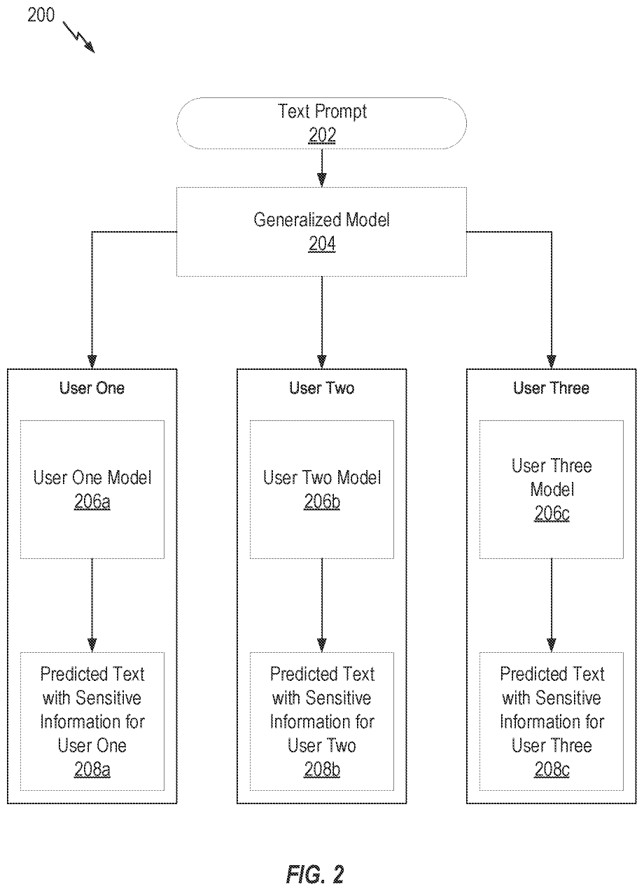

FIG. 2 depicts an example personalized predictive model architecture 200 for generating predicted text comprising sensitive information, such as prediction model 108 in FIG. 1.

Generalized model 204 is configured to predict anonymized text based on a provided text prompt 202 for predicted text. In some embodiments, generalized model 204 may be generalized model 104 in FIG. 1. Text prompt 202 may be a prompt for predicted text based on the user inputting the text. For example, user one may provide a prompt to “generate an invoice for landscape services.”

In one embodiment, generalized model 204 is configured to predict anonymized output, such as an anonymized text string. The anonymized text string, for example, may contain a placeholder representing sensitive information. For example, the anonymized output generated based on a prompt “generate an invoice for landscape services” may include an invoice with sections for a company name, company contact information, a description of services, a price of services, etc. In embodiments, generalized model 204 may be user-agnostic, such that output generated by generalized model 204 may be the same irrespective of the user giving the prompt. For example, the anonymized text string generated by generalized model 204 may be the same regardless of whether the prompt is provided by user one, user two, or user three.

The anonymized output generated by generalized model 204 is provided to one or more user-specific models, such as user model 106 in FIG. 1, to predict personalized or user-specific text based on the anonymized output. In this example, three user-specific models are depicted, user one model 206a, user two model 206b, and user three model 206c (collectively “user-specific models 206”). In some aspects, example model architecture 200 may comprise fewer or additional models user-specific models.

In one embodiment, the anonymized output generated by generalized model 204 is provided to a user-specific model based on the user providing text prompt 202. In embodiments, an identifier provided in the prompt is used by the generalized model to determine the user-specific model to which the anonymized output is provided. For example, where user one provided text prompt 202 to generalized model 204, the output generated by generalized model 204 is provided to user one model 206a based on an identifier associated with user one. Where user two provided text prompt 202 to generalized model 204, the output from generalized model 204 is provided to user two model 206b based on an identifier associated with user two. Similarly, where user three provided text prompt 202, the output is provided to user three model 206c based on an identifier associated with user three.

The user-specific models 206 are configured to determine personalized text, such as text containing sensitive information based on the anonymized output. Where the anonymized output contains a placeholder representing sensitive information, the user-specific models 206 are configured to determine the user-specific information to replace the placeholder. The user-specific models 206 are configured to determine the most probable sensitive information for a given placeholder in the anonymized output, given the placeholder and surrounding text in the anonymized output. In some embodiments, the user-specific models 206 are multinomial naive Bayes models. The user-specific models 206 may be trained to determine the probability of a specific token of sensitive information for the category of each placeholder in the anonymized output using the words surrounding the placeholder as features. For example, given hyperparameter K, the surrounding words may be determined as K words previous to the placeholder and K words subsequent to the placeholder.

In embodiments, user one model 206a is configured to receive output from generalized model 204 containing one or more placeholders and determine sensitive information associated with user one for each of the one or more placeholders. For example, user one model 206a receives anonymized output including an invoice with a placeholder for a company name. User one model 206a determines the user one-specific company name for the placeholder based on the surrounding text and user one specifics.

The user-specific models 206 are further configured to replace each placeholder with the determined user-specific information in the anonymized output to generate personalized output for the user. For example, where user one model 206a determined the user one-specific company name for the placeholder in the anonymized output, the placeholder is replaced with the user one-specific company name to generate personalized output for user one. Beneficially, then, user one receives personalized predictive text containing sensitive information, but user one's sensitive information is not exposed to other users. Additionally, the predicted text is generated with a powerful prediction model, in this example, generalized model 204.

In embodiments, where the user giving the prompt is user two, generalized model 204 is configured to provide anonymized output to user two model 206b. User two model 206b determines sensitive information associated with user two for each of one or more placeholders within the anonymized output and replaces the placeholders with the determined sensitive information. Beneficially, then, user two may also receive personalized predicted text containing sensitive information.

In embodiments, where the user giving the prompt is user three, generalized model 204 is configured to provide anonymized output to user three model 206c. User three model 206c determines sensitive information associated with user three for each of one or more placeholders within the anonymized output and replaces the placeholders with the determined sensitive information. Beneficially, then, the model may be utilized by various users, in this example, three users, to generate personalized predicted text while maintaining the privacy of sensitive information for each user but retaining the power of a generalized model.

### Example Flowchart for Predicting Text Comprising Sensitive Information

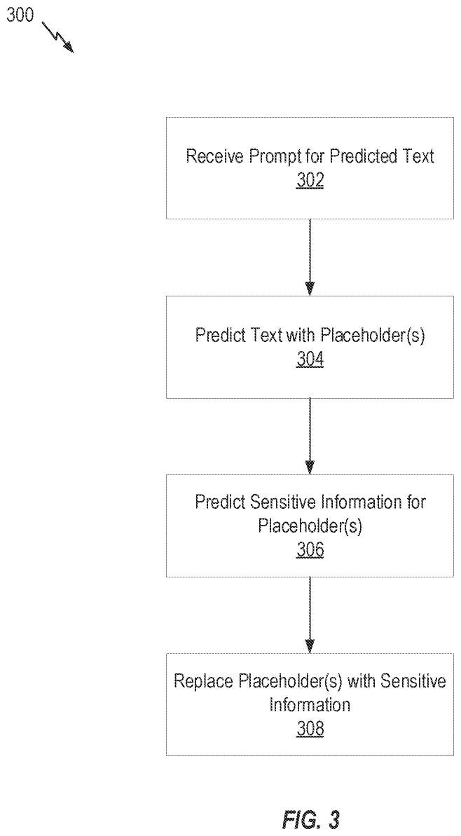

FIG. 3 depicts an example flowchart for predicting text comprising sensitive information with a prediction model, such as prediction model 108 in FIG. 1, or model architecture 200 as described with respect to FIG. 2.

Initially, flow 300 begins at step 302 with receiving a prompt for predicting text from a first user with the personalized predictive model architecture. For example, a prompt may be to generate an invoice for the first user.

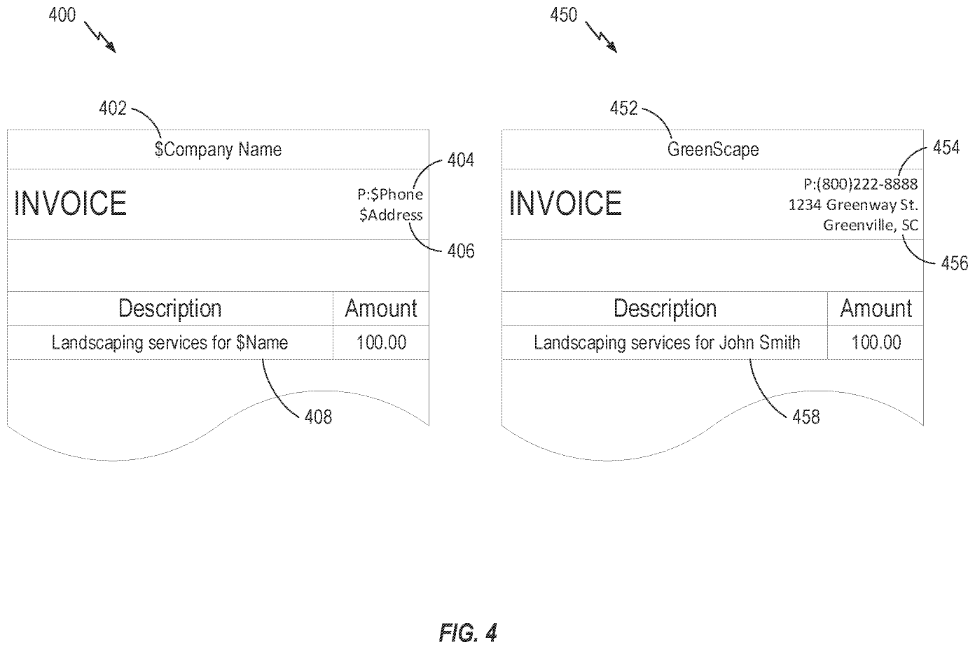

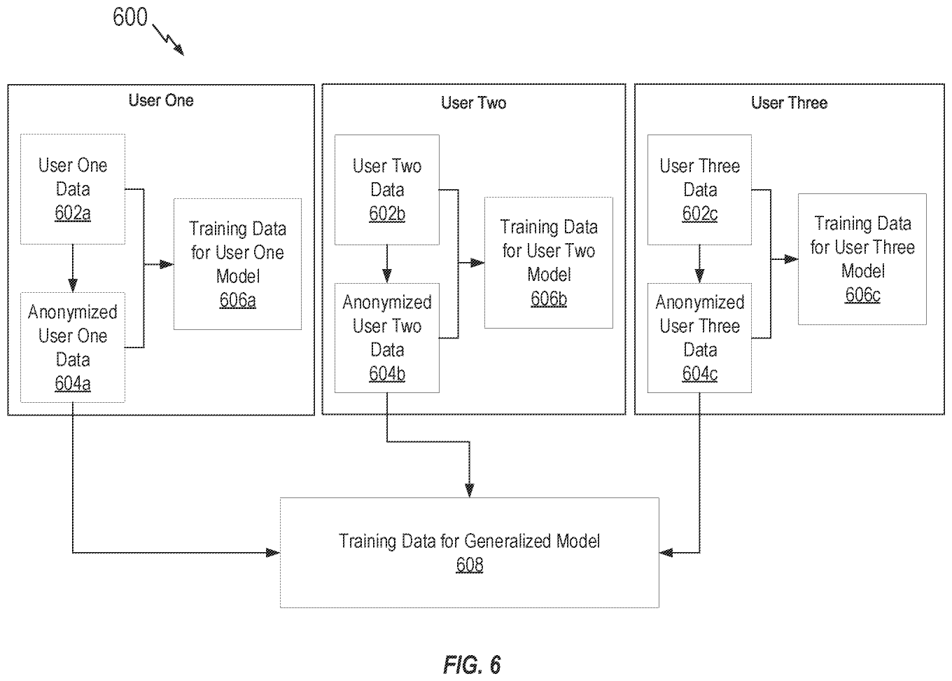

Flow 300 proceeds to step 304 with predicting text with a generalized model based on the prompt received at step 302. The generalized model is trained to generate anonymized predicted text. In some embodiments, the generalized model is generalized model 104 in FIG. 1, or generalized model 602 in FIG. 6. The predicted text contains one or more category placeholders instead of any sensitive information. Beneficially, then, the generalized model will not output sensitive information and may be used by multiple users. For example, given the prompt to generate an invoice for the first user, the anonymized predicted text may be invoice 400 in FIG. 4.

Flow 300 then proceeds to step 306 with predicting sensitive information for the category placeholders in the predicted text at step 304 with a user model for the first user. In some embodiments, the user model for the first user is user one model 206a in FIG. 2. In some embodiments, the user model is selected in response to the user providing the prompt. For example, the user model may be determine based on an identifier included in the prompt, indicating the user model to be selected.

Flow 300 then proceeds to step 308 with replacing the one or more placeholders in the anonymized predicted text to generate personalized text. For example, given the prompt to generate an invoice for the first user. For example, given the prompt to generate an invoice for the first user, the personalized predicted output may be invoice 450 in FIG. 4. Beneficially, then, the final predicted text is personalized for the first user with sensitive information, while benefiting from a generalized model, while maintaining user-specific privacy.

Note that flow 300 is just one example, and other flows including fewer, additional, or alternative steps, consistent with this disclosure, are possible.

### Example Text Predictions Using a Prediction Model

FIG. 4 depicts example predictive text, such as may be generated using the machine learning model architectures described herein, for example, prediction model 108 in FIG. 1, or model architecture 200 in FIG. 2.

Invoice 400 is an example output of a generalized model, such as generalized model 104 in FIG. 1, or generalized model 204 in FIG. 2. As described above, a prompt, such as text prompt 202 in FIG. 2, may be provided to the generalized model to generate anonymized predicted text. For example, given a prompt to generate a landscaping invoice for a first user, the generalized model may generate invoice 400.

Invoice 400 incudes predicted text and predicted placeholders. Each placeholder represents user-specific information, such as sensitive information. Placeholder 402 relates to a company name. Placeholder 404 relates to a phone number. Placeholder 406 relates to an address. Placeholder 408 relates to a customer name. Beneficially, using a generalized model to general anonymized text, such as invoice 400, the generalized model may be used for multiple users without reducing privacy of sensitive information.

Invoice 400 may be provided to a user-specific model for the first user, such as user model 106 in FIG. 1, or user one model 206a in FIG. 2. The user model may generate invoice 450 which includes the predicted text from the generalized model and sensitive information for the first user replacing the placeholders. The user model determined sensitive information, for example, company name 452 based on placeholder 402 in invoice 400, for the first user. Further, as depicted in invoice 450, company name 452 replaces placeholder 402. Additionally, user model determined phone number 454 to replace placeholder 404, address 456 for placeholder 406, and customer name 458 for placeholder 408. Thus, beneficially, personalized invoice 450 may be generated using a user model to provide personalized predictive text.

### Example Training System for a Prediction Model

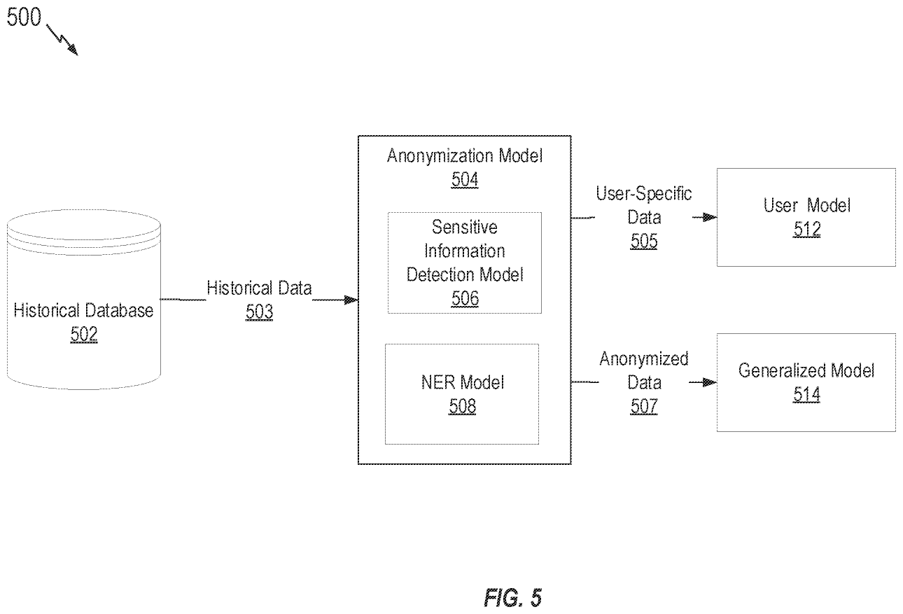

FIG. 5 depicts an example training system 500 for training a prediction model to predict text containing sensitive information, such as prediction model 108 in FIG. 1, or model architecture 200 in FIG. 2.

Anonymization model 504 is configured to extract features from historical data 503 obtained from historical database 502 to generate anonymized training data 507 for generalized model 514. Anonymization model 504 is further configured to generate user-specific data 505 for user model 512 using data from historical database 502.

In the depicted example, anonymization model 504 comprises sensitive information detection model 506 and named entity recognition (NER) model 508. Sensitive information detection model 506 is trained to detect “tokens” of sensitive information (e.g., PII) within the historical data 503 obtained from historical database 502. Further, sensitive information detection model 506 determines whether each token is sensitive information using a k-anonymity method. In some aspects, sensitive information detection model 506 enforces k-anonymity on the token-level. For example, a token is determined to not be sensitive information if the token appears for at least k=2 different users. If a token appears for only one user, the token is determined to have sensitive information.

NER model 508 is configured to assign each token predicted to include sensitive information to a category (or label), such as from a taxonomy of known sensitive information categories. Predicted categories may be mapped to categorical placeholders that take the place of any sensitive information in an anonymized output from anonymization model 504, For example, categories may include person names, personal identifiers (e.g., social security numbers, driver's license numbers, passport number, etc.), organizations, locations (e.g., home and work addresses), etc. For example, as described with respect to FIG. 4, placeholder 402 may be a category of company name, placeholder 404 a category of phone number, placeholder 406 may be a category of address, and placeholder 408 may be a category of person name.

For example, given the input string “Landscaping services for John Smith”, sensitive information detection model 506 may predict “John Smith” (a token) is sensitive information and NER model 508 may categorize “John Smith” as a “person name.” Then an anonymized input string can be generated omitting the predicted sensitive information and including a placeholder specific to the predicted category of the predicted sensitive information, such as “Landscaping services for $Name” such as depicted in FIG. 4.

As described above, generalized model 514 is configured to generate anonymized text based on a prompt. Generalized model 514 is trained with anonymized training data 507.

User model 512 is configured to determine sensitive information (or token), for a given placeholder and surrounding data. In some embodiments, user model 512 may be user model 106 in FIG. 1, or one or more of user-specific models 206 in FIG. 2. User model 512 is trained to determine a probability for each token of sensitive information given its placeholder's category (such as determined by NER model 508), and the surrounding words, such as K previous words and K subsequent words. User model 512 is trained with user-specific data 505, which includes both the historical data associated with the user and the anonymized data associated with the user.

### Example Data Flow for Training a Model

FIG. 6 depicts an example data flow for generating training data for a generalized model, such as generalized model 514 of FIG. 5, and for a user model, such as user model 512 in FIG. 5. In this example, data and models for three users are depicted, although data and models for fewer or additional users are contemplated.

For user one, features are extracted from user one data 602a to generate anonymized user one data 604a, using an anonymization model, such as anonymization model 504 of FIG. 5. The features extracted from user one data 602a may include text and associated descriptions. For example, where the data includes an invoice, the features extracted may include an organization identifier, data and time, customer information, item or service, industry, etc. within the invoice.

A sensitive information detection model, such as sensitive information detection model 506 in FIG. 5, determines tokens with sensitive information. A NER model, such as NER model 508, assigns a category placeholder for each token with sensitive information. For example, where if “John Smith” is a determined token with sensitive information, “John Smith” may be assigned to a “person names” category placeholder. Then, tokens with sensitive information in user one data 602a are replaced with the assigned category placeholder(s).

Anonymized user one data 604a and user one data 602a are used as training data for a user one model. As described above, a user one model is trained to determine the most probable sensitive information for a placeholder based on the category and surrounding information.

Data for user two and user three is processed in the same manner as for user one. For example, user two data 602b is anonymized to generate anonymized user two data 604b. This data is used as training data for user two model 606b. In another example, user three data 602c is anonymized to generate anonymized user three data 604c. This data is used as training data for user three model 606c.

Anonymized user one data 604a, anonymized user two data 604b, and anonymized user three data 604 are used as training data 608 for a generalized model, such as generalized text prediction model 112 in FIG. 1.

Although training data 608 is depicted in this example as from three users, training data 608 may generated for any number of users. Beneficially, this allows for aggregating data across users so that a generalized model can be trained with more data without exposing sensitive information between users during training.

### Example Method for Training a Prediction Model

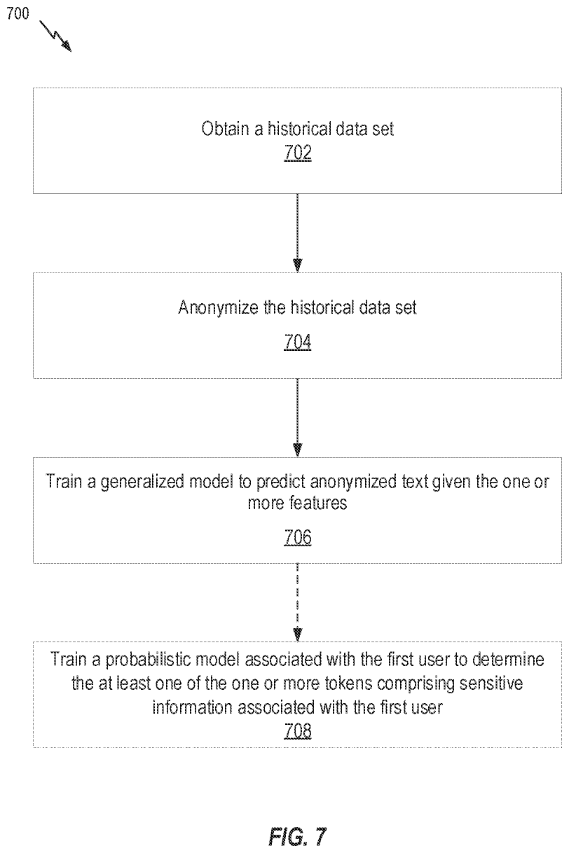

FIG. 7 depicts an example method 700 for training a machine learning model to predict text comprising sensitive information, such as described with respect to flow 600 in FIG. 6.

Initially, method 700 begins at step 702 with obtaining a historical data set; such as historical data 503 in FIG. 5, user one data 602a, user two data 602b, or user three data 602c in FIG. 6. In some embodiments, the historical data set comprises a plurality of data sets, wherein each data set is associated with a different user. For example, the historical data set may include user one data 602a, user two data 602b, and user three data 602c in FIG. 6.

Method 700 proceeds to step 704 with anonymizing the historical data set, using an anonymization model, such as anonymization model 504 in FIG. 5. For example, anonymized historical data set may include anonymized user one data 604a, anonymized user two data 604b, and anonymized user three data 604c in FIG. 6. In some embodiments, anonymizing the historical data set includes, determining one or more tokens containing sensitive information from the historical data set; assigning a category placeholder to each of the one or more tokens containing sensitive information; and generating a new data set where each token containing sensitive information is replaced with the assigned category placeholder.

In some embodiments, determining the one or more tokens containing sensitive information from the historical data set includes extracting features from the historical data set; and processing the extracted features with a sensitive information detection model, such as sensitive information detection model 506 in FIG. 5, to determine the one or more tokens comprising sensitive information, such as for user one data 602a in FIG. 6. The extracted features may include text and associated descriptions from the historical data. In some embodiments, determining the one or more tokens containing sensitive information from the historical data set, further includes enforcing k-anonymity on the one or more tokens comprising sensitive information, comprising determining each of the one or more tokens comprising sensitive information is associated with only one user.

In some embodiments, assigning the category placeholder to each of the one or more tokens containing sensitive information, includes processing each of the one or more tokens with a named entity recognition model, such as NER model 508 in FIG. 5, to determine the corresponding category, wherein the corresponding category is from a taxonomy of known sensitive information categories, such as described with respect to generating anonymized user one data 604a in FIG. 6.

Method 700 then proceeds to step 706 with training a generalized model, such as generalized model 104 in FIG. 1, generalized model 204 in FIG. 2, or generalized model 514 to predict anonymized text with the new data set. The generalized model is trained with the anonymized historical data set, such as training data 608 in FIG. 6. In some embodiments, the generalized model is a long short-term memory model.

In some embodiments, method 700 then proceeds to step 708 with training a probabilistic model associated with the first user, such as user one model 206a in FIG. 2, to determine the at least one of the one or more tokens comprising sensitive information associated with the first user, where the historical data set includes a first data set associated with the first user, and at least one or more tokens comprising sensitive information is associated with the first user. In some embodiments, the probabilistic model associated with the first user is a multinomial naive Bayes model. For example, as described with respect to FIG. 5, user-specific data 505 is used to train user model 512, which may be a probabilistic model. In another example, as described with respect to FIG. 6, user one data 602a and anonymized user one data 604a from training data 606a for a probabilistic model for user one.

In some embodiments, method 700 further includes receiving, from the first user, such as user 102 in FIG. 1, a prompt for predicted text; generating anonymized predicted text with the trained generalized model, such as generalized model 104 FIG. 1, based on the prompt for predicted text; and generating personalized text with the trained probabilistic model, such as user model 106 in FIG. 1, associated with the first user, wherein the personalized text comprises sensitive information associated with the first user.

In some embodiments, method 700 further includes training a probabilistic model associated with the second user, such as user two model 206b in FIG. 2, to determine at least one of the one or more tokens comprising sensitive information associated with the second user; and the historical data set comprises a second data set associated with a second user, such as user two data 602b in FIG. 6, and at least one of the one or more tokens comprising sensitive information is associated with the second user.

In some embodiments, method 700 further includes receiving a prompt for predicted text, such as text prompt 202 in FIG. 2, from the second user; generating anonymized predicted text with the trained generalized model, such as generalized model 204 in FIG. 2, based on the prompt for predicted text from the second user; and generating personalized text, such as predicted text with sensitive information for user two 208b in FIG. 2, with the trained probabilistic model associated with the second user, such as user two model 206b in FIG. 2, wherein the personalized text comprises sensitive information associated with the second user.

Note that method 700 is just one example, and other methods including fewer, additional, or alternative steps, consistent with this disclosure, are possible.

### Example Method for Predicting Sensitive Text

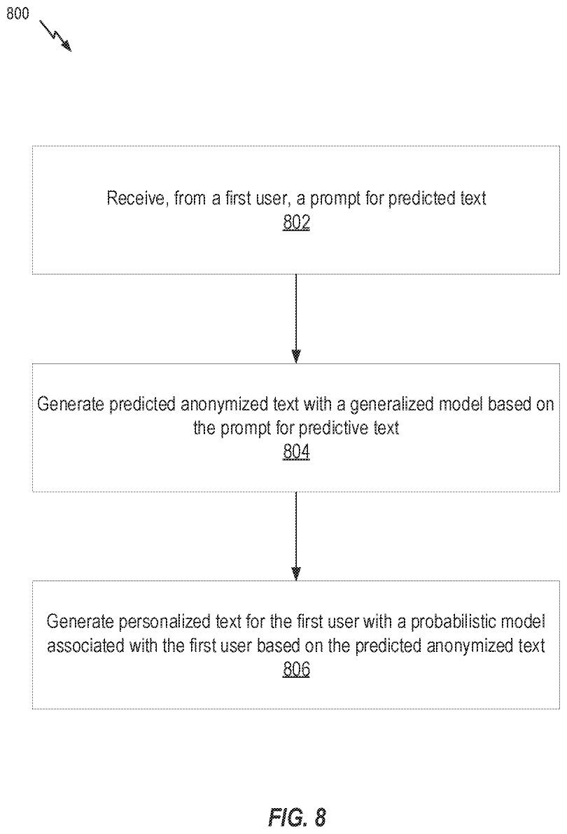

FIG. 8 depicts an example method 800 for predicting text comprising sensitive information, such as described with respect to model architecture 200 in FIG. 2.

Initially, method 800 begins at step 802 with receiving, from a first user, a prompt for predicted text, such as text prompt 202 in FIG. 2.

Method 800 proceeds to step 804 with generating predicted anonymized text with a generalized model, such as generalized model 104 in FIG. 1, generalized model 204 in FIG. 2, or generalized model 514, based on the prompt for predictive text, such as described with respect to step 304 in FIG. 3. In some embodiments, the generalized model comprises a long short-term memory network.

In some embodiments, the predicted anonymized text comprises one or more category placeholders representing sensitive information, for example, invoice 400 described with respect to FIG. 4. In some embodiments, each of the one or more category placeholders are associated with a named entity recognition category, such as from NER model 508 in FIG. 5.

Method 800 then proceeds to step 806 with generating predicted personalized text, such as predicted text with sensitive information for user one 208a in FIG. 2, for the first user with a probabilistic model associated with the first user based on the predicted anonymized text for example, invoice 450 described with respect to FIG. 4.

In some embodiments, generating the predicted personalized text, includes processing each of the one or more category placeholders with the probabilistic model, for example, user model 106 in FIG. 1, or user one model 206a in FIG. 2, to determine corresponding sensitive information associated with the first user, wherein the probabilistic model is trained to determine the most probable sensitive information associated with the first user for each of the one or more category placeholders based on the predicted anonymized text, such as described with respect to step 306 in FIG. 3; and replacing each of the one or more category placeholders of the predicted anonymized text with the corresponding sensitive information to generate the predicted personalized text, such as described with respect to step 308 in FIG. 3. In some embodiments, the probabilistic model associated with the first user comprises a multinomial naive Bayes model.

Note that method 800 is just one example, and other methods including fewer, additional, or alternative steps, consistent with this disclosure, are possible.

### Example Processing System for Predicting Text Containing Sensitive Information

FIG. 8 depicts an example processing system 900 configured to perform various aspects described herein, including, for example, flow 600 described with respect to FIG. 6, method 700 described with respect to FIG. 7, or method 800 described with respect to FIG. 8.

Processing system 900 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 900 includes one or more processors 902, one or more input/output devices 904, one or more display devices 906, and one or more network interfaces 908 through which processing system 900 is connected to one or more networks (e.g., a local network, an intranet, the Internet, or any other group of processing systems communicatively connected to each other), and computer-readable medium 912.

In the depicted example, the aforementioned components are coupled by a bus 910, which may generally be configured for data and/or power exchange amongst the components. Bus 910 may be representative of multiple buses, while only one is depicted for simplicity.

Processor(s) 902 are generally configured to retrieve and execute instructions stored in one or more memories, including local memories like the computer-readable medium 912, as well as remote memories and data stores. Similarly, processor(s) 902 are configured to retrieve and store application data residing in local memories like the computer-readable medium 912, as well as remote memories and data stores. More generally, bus 910 is configured to transmit programming instructions and application data among the processor(s) 902, display device(s) 906, network interface(s) 908, and computer-readable medium 912. In certain embodiments, processor(s) 902 are included to be representative of a one or more central processing units (CPUs), graphics processing unit (GPUs), tensor processing unit (TPUs), accelerators, and other processing devices.

Input/output device(s) 904 may include any device, mechanism, system, interactive display, and/or various other hardware components for communicating information between processing system 900 and a user of processing system 900. For example, input/output device(s) 904 may include input hardware, such as a keyboard, touch screen, button, microphone, and/or other device for receiving inputs from the user. Input/output device(s) 904 may further include display hardware, such as, for example, a monitor, a video card, and/or other another device for sending and/or presenting visual data to the user. In certain embodiments, input/output device(s) 904 is or includes a graphical user interface.

Display device(s) 906 may generally include any sort of device configured to display data, information, graphics, user interface elements, and the like to a user. For example, display device(s) 906 may include internal and external displays such as an internal display of a tablet computer or an external display for a server computer or a projector. Display device(s) 906 may further include displays for devices, such as augmented, virtual, and/or extended reality devices.

Network interface(s) 908 provide processing system 900 with access to external networks and thereby to external processing systems. Network interface(s) 908 can generally be any device capable of transmitting and/or receiving data via a wired or wireless network connection. Accordingly, network interface(s) 908 can include a communication transceiver for sending and/or receiving any wired and/or wireless communication. For example, Network interface(s) 908 may include an antenna, a modem, a LAN port, a Wi-Fi card, a WiMAX card, cellular communications hardware, near-field communication (NFC) hardware, satellite communication hardware, and/or any wired or wireless hardware for communicating with other networks and/or devices/systems. In certain embodiments, network interface(s) 908 includes hardware configured to operate in accordance with the Bluetooth® wireless communication protocol.

Computer-readable medium 912 may be a volatile memory, such as a random access memory (RAM), or a nonvolatile memory, such as nonvolatile RAM, phase change random access memory, or the like. In this example, computer-readable medium 912 includes extracting component 914, anonymizing component 916, determination component 918, training component 920, generation component 922, training data 924, historical data 926, anonymized data 928, sensitive information detection model 930, NER model 932, probabilistic model 934, or generalized model 936.

In certain embodiments, extracting component 914 is configured to extract features from historical data 926, such as historical data 503 in FIG. 5, user one data 602a, user two data 602b, or user three data 602c in FIG. 6.

In certain embodiments, anonymizing component 916 is configured to anonymize the historical data set, for example, through an anonymization model, such as anonymization model 504 in FIG. 5, to generate anonymized data 928, such as anonymized user one data 604a, anonymized user two data 604b, or anonymized user three data 604c in FIG. 6. An anonymization model may comprise sensitive information detection model 930, such as sensitive information detection model 506 in FIG. 1, and NER model 932, such as NER model 508 in FIG. 5.

In certain embodiments, determination component 918 is configured to determine the one or more tokens containing sensitive information from the historical data set, for example, through sensitive information detection model 930.

In certain embodiments, training component 920 is configured to train a generalized model, such as generalized model 936, to predict anonymized text given the one or more features from historical data 926. In some embodiments, generalized model 936 may be, for example, generalized model 104 in FIG. 1, generalized model 514 in FIG. 5, or generalized model 204 in FIG. 2. Generalized model 936 may be trained with training data 924. In some embodiments, training data 924 may include anonymized data 928. In certain embodiments, training component 920 is further configured to train one or more probabilistic models, such as, user model 106 in FIG. 1, or user one model 206a, user two model 606b, and user three model 606c in FIG. 2.

In certain embodiments, generation component 922 is configured to generate predicted anonymized text, such as with generalized model 936, or generate personalized text for a user, with probabilistic model 934.

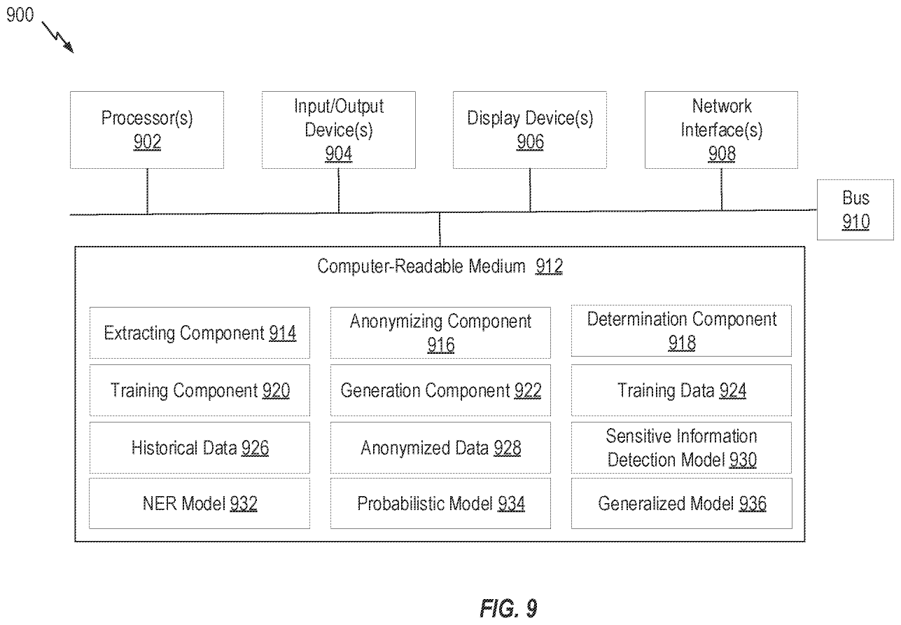

Note that FIG. 9 is just one example of a processing system consistent with aspects described herein, and other processing systems having additional, alternative, or fewer components are possible consistent with this disclosure.

### Example Clauses

Implementation examples are described in the following numbered clauses:

Clause 1: A method of training a machine learning model to predict text containing sensitive information, comprising: obtaining a historical data set; anonymizing the historical data set, comprising: determining one or more tokens containing sensitive information from the historical data set; assigning a category placeholder to each of the one or more tokens containing sensitive information; and generating a new data set where each token containing sensitive information is replaced with the assigned category placeholder; and training a generalized model to predict anonymized text with the new data set.

Clause 2: The method of Clause 1, wherein determining the one or more tokens comprising sensitive information from the historical data set, comprises: extracting features from the historical data set; and processing the extracted features with a sensitive information detection model to determine the one or more tokens comprising sensitive information.

Clause 3: The method of Clause 2, wherein determining the one or more tokens containing sensitive information from the historical data set, further comprises: enforcing k-anonymity on the one or more tokens comprising sensitive information, comprising determining each of the one or more tokens comprising sensitive information is associated with only one user.

Clause 4: The method of any one of Clauses 1-3, wherein assigning the category placeholder to each of the one or more tokens containing sensitive information, comprises processing each of the one or more tokens with a named entity recognition model to determine the corresponding category, wherein the corresponding category is from a taxonomy of known sensitive information categories.

Clause 5: The method of any one of Clauses 1-4, wherein: the historical data set comprises a first data set associated with a first user; and at least one of the one or more tokens comprising sensitive information is associated with the first user; and the method further comprises: training a probabilistic model associated with the first user to determine the at least one of the one or more tokens comprising sensitive information associated with the first user.

Clause 6: The method of Clause 5, further comprising: receiving, from the first user, a prompt for predicted text; generating anonymized predicted text with the trained generalized prediction model based on the prompt for predicted text; and generating personalized text with the trained probabilistic model associated with the first user, wherein the personalized text comprises sensitive information associated with the first user.

Clause 7: The method of any one of Clause 5-6, wherein the probabilistic model associated with the first user is a multinomial naive Bayes model.

Clause 8: The method of any one of Clauses 5-7, wherein: the historical data set comprises a second data set associated with a second user; and at least one of the one or more tokens comprising sensitive information is associated with the second user; and the method further comprises: training a probabilistic model associated with the second user to determine the at least one of the one or more tokens comprising sensitive information associated with the second user.

Clause 9: The method of Clause 8, further comprising: receiving a prompt for predicted text, from the second user; generating anonymized predicted text with the trained generalized prediction model based on the prompt for predicted text from the second user; and generating personalized text with the trained probabilistic model associated with the second user, wherein the personalized text comprises sensitive information associated with the second user.

Clause 10: The method of any one of Clauses 1-9, wherein the generalized model comprises a long short-term memory network.

Clause 11: The method of any one of Clauses 1-10, wherein the historical data set comprises a plurality of data sets, wherein each data set is associated with a different user.

Clause 12: A method for predicting text comprising sensitive information, comprising: receiving, from a first user, a prompt for predicted text; generating predicted anonymized text with a generalized model based on the prompt for predictive text; and generating predicted personalized text for the first user with a probabilistic model associated with the first user based on the predicted anonymized text.

Clause 13: The method of Clause 12, wherein the predicted anonymized text comprises one or more category placeholders representing sensitive information.

Clause 14: The method of Clause 13, wherein each of the one or more category placeholders are associated with a named entity recognition category.

Clause 15: The method of any one of Clauses 13-14, wherein generating the predicted personalized text for the first user with a probabilistic model associated with the first user based on the predicted anonymized text comprises: processing each of the one or more category placeholders with the probabilistic model to determine corresponding sensitive information associated with the first user, wherein the probabilistic model is trained to determine the most probable sensitive information associated with the first user for each of the one or more category placeholders based on the predicted anonymized text; and replacing each of the one or more category placeholders of the predicted anonymized text with the corresponding sensitive information to generate the predicted personalized text.

Clause 16: The method of any one of Clauses 12-15, wherein the generalized model comprises a long short-term memory network.

Clause 17: The method of any one of Clauses 12-15, wherein the probabilistic model associated with the first user comprises a multinomial naive Bayes model.

Clause 18: A processing system, comprising: a memory comprising computer-executable instructions; and a processor configured to execute the computer-executable instructions and cause the processing system to perform a method in accordance with any one of Clauses 1-17.

Clause 19: A processing system, comprising means for performing a method in accordance with any one of Clauses 1-17.

Clause 20: A non-transitory computer-readable medium storing program code for causing a processing system to perform the steps of any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method of training a machine learning model to predict text containing sensitive information, comprising:
obtaining a historical data set from a database;
anonymizing the historical data set, comprising:
extracting one or more tokens containing sensitive information from the historical data set:
assigning a category placeholder to each of the one or more tokens containing sensitive information, wherein the category placeholder represents sensitive information; and
generating a new data set wherein each token containing sensitive information in the historical data set is replaced with the assigned category placeholder; and
training, with the new data set, a generalized model to generate anonymous predicted text based on a prompt, wherein:
the anonymous predicted text comprises one or more predicted category placeholders, and
each of the one or more predicted category placeholders represents sensitive information.

2. The computer-implemented method of claim 1, wherein determining the one or more tokens comprising sensitive information from the historical data set, comprises:
extracting features from the historical data set; and
processing the extracted features with a sensitive information detection model to determine the one or more tokens comprising sensitive information.

3. The computer-implemented method of claim 2, wherein determining the one or more tokens containing sensitive information from the historical data set, further comprises:
enforcing k-anonymity on the one or more tokens comprising sensitive information, comprising determining each of the one or more tokens comprising sensitive information is associated with only one user.

4. The computer-implemented method of claim 1, wherein assigning the category placeholder to each of the one or more tokens containing sensitive information, comprises processing each of the one or more tokens with a named entity recognition model to determine a corresponding category, wherein the corresponding category is from a taxonomy of known sensitive information categories.

5. The computer-implemented method of claim 1, wherein:
the historical data set comprises a first data set associated with a first user; and
at least one of the one or more tokens comprising sensitive information is associated with the first user; and the method further comprises:
training a probabilistic model associated with the first user to determine sensitive information associated with the first user based on the one or more predicted category placeholders of the anonymous predicted text.

6. The computer-implemented method of claim 5, further comprising:
receiving, from the first user, a first user prompt for predicted text:
generating anonymized predicted text with the trained generalized model based on the first user prompt for predicted text comprising a predicted category placeholder;
predicting first user-specific sensitive information with the trained probabilistic model associated with the first user; and
replacing the predicted category placeholder with the first user-specific sensitive information to generate personalized text for the first user.

7. The computer-implemented method of claim 5, wherein the probabilistic model associated with the first user is a multinomial naive Bayes model.

8. The computer-implemented method of claim 5, wherein:
the historical data set comprises a second data set associated with a second user; and
at least one of the one or more tokens comprising sensitive information is associated with the second user; and the method further comprises:
training a probabilistic model associated with the second user to determine the at least one of the one or more tokens comprising sensitive information associated with the second user.

9. The computer-implemented method of claim 8, further comprising:
receiving, from the second user, a second user prompt for predicted text;
generating second anonymized predicted text with the trained generalized model based on the second user prompt for predicted text from the second user comprising a second predicted category placeholder; and
predicting second user-specific sensitive information text with the trained probabilistic model associated with the second user; and
replacing the second predicted category placeholder with the second user-specific sensitive information to generate personalized text for the second user.

10. The computer-implemented method of claim 1, wherein the generalized model comprises a long short-term memory network.

11. The computer-implemented method of claim 1, wherein the historical data set comprises a plurality of data sets, wherein each data set is associated with a different user.

12. A computer-implemented method for predicting text comprising sensitive information, comprising:
receiving, from a first user, a prompt for predicted text;
generating anonymous predicted text with a generalized model based on the prompt for predictive text, wherein the anonymous predicted text comprises one or more predicted category placeholders;
predicting user-specific sensitive information for the first user with a probabilistic model associated with the first user based on the anonymous predicted text and the one or more predicted category placeholders; and
replacing the one or more predicted category placeholders in the anonymous predicted text with the user-specific sensitive information to generate personalized text for the first user.

13. (canceled)

14. The computer-implemented method of claim 12, wherein each of the one or more predicted category placeholders are associated with a named entity recognition category.

15. The computer-implemented method of claim 12, wherein predicting the user-specific sensitive information for the first user with the probabilistic model associated with the first user based on the anonymous predicted text and the one or more predicted category placeholders comprises:
processing each of the one or more predicted category placeholders with the probabilistic model to determine corresponding user-specific sensitive information associated with the first user, wherein the probabilistic model is trained to determine most probable sensitive information associated with the first user for each of the one or more predicted category placeholders based on the anonymous predicted text; and
replacing the one or more predicted category placeholders in the anonymous predicted text with the user-specific sensitive information to generate the personalized text for the first user, comprises:
replacing each of the one or more predicted category placeholders in the anonymous predicted text with the corresponding user-specific sensitive information to generate the personalized text for the first user.

16. The computer-implemented method of claim 12, wherein the generalized model comprises a long short-term memory network.

17. The computer-implemented method of claim 12, wherein the probabilistic model associated with the first user comprises a multinomial naive Bayes model.

18. A processing system, comprising: a memory comprising computer-executable instructions; and a processor configured to execute the computer-executable instructions and cause the processing system to predict text containing sensitive information, comprising:
obtain a historical data set from a database;
anonymize the historical data set, comprising:
extract one or more tokens containing sensitive information from the historical data set;
assign a category placeholder to each of the one or more tokens containing sensitive information, wherein the category placeholder represents sensitive information; and
generate a new data set wherein each token containing sensitive information in the historical data set is replaced with the assigned category placeholder; and
train, with the new data set, a generalized model to generate anonymous predicted text based on a prompt, wherein:
the anonymous predicted text comprises one or more predicted category placeholders, and
each of the one or more predicted category placeholders represents sensitive information.

19. The processing system of claim 18, wherein:
the historical data set comprises a first data set associated with a first user;
at least one of the one or more tokens containing sensitive information is associated with the first user; and
the processor is further configured to:
train a probabilistic model associated with the first user to determine sensitive information associated with the first user based on the one or more predicted category placeholders of the anonymous predicted text.

20. (canceled)

21. The computer-implemented method of claim 12, wherein the prompt for predicted text comprises an identifier associated with the first user, and the method further comprises determining the probabilistic model associated with the first user based on the identifier associated with the first user.

22. The computer-implemented method of claim 12, further comprising:
receiving, from a second user, a second user prompt for predicted text:
generating subsequent anonymized predicted text with the generalized model based on the second user prompt for predicted text from the second user comprising a second predicted category placeholder; and
predicting second user-specific sensitive information personalized text for the second user with a probabilistic model associated with the second user based on the predicted anonymized text and the predicted one or more category placeholders; and
replacing the second predicted category placeholder with the second user-specific sensitive information to generate personalized text for the second user.
